(19) United States
(12) Patent Application Publication
(10) Pub. No.: US 2006/0248130 A1
(43) Pub. Date: Nov. 2, 2006

(54) Process and system for real-time relocation of objects during garbage collection

(76) Inventors: Steffen Grarup, Hoejbjerg (DK); Lars Bak, Tranbjerg J. (DK); Kasper Verdich Lund, Hoejbjerg (DK); Jakob Roland Andersen, Hoejbjerg (DK)

Correspondence Address: PERKINS COIE LLP, P.O. BOX 2168, MENLO PARK, CA, 94026, US

(21) Appl. No.: 11/112,961

(22) Filed: Apr. 22, 2005

(51) Int. Cl. G06F 17/30

(52) U.S. Cl. 707/206

(57) ABSTRACT

A technique for dynamically relocating an object during garbage collection involves guaranteeing bounds on thread pause times. A process according to the technique may include pausing threads, bounding pause times by scanning only one of a plurality of threads, and resuming the threads. Another process according to the technique may include suspending a plurality of threads, relocating an object to a new memory location, updating references associated with an old memory location for only one of the threads such that the references are associated with the new memory location, and resuming the threads. In an embodiment, the process may include initially marking each of the threads “unscanned.” In another embodiment, the process may include reading the object from the first memory location and writing the object to the second memory location. An example system according to the technique may include a scheduler and a relocation engine. In an embodiment, the scheduler may suspend threads in preparation for dynamic object relocation and then resumes the threads after scanning one, and only one, of the thread stacks. In an embodiment, the thread associated with the scanned thread stack may then be marked “scanned.”

### BACKGROUND

The present invention relates to computer memory management. More particularly, the present invention relates to garbage collection.

An important task in computer systems is the task of allocating memory to data objects. The term object refers to a data structure represented in a computer system memory. An object is identified by a reference, also known as a pointer, which is a small amount of information that is used to access the object. Typically, a reference to an object is the memory address of the object, but there are other ways to represent a reference.

An object may contain a number of fields of data, which can be characters, integers, references, or other types of data. In object-oriented systems, objects are data structures that encapsulate data and methods that operate on that data. Objects are instances of classes, where a class includes method code and other information that is common to all objects belonging to the class. Methods, which define actions the class can perform, may be invoked using the reference to the object.

In a system that allocates memory to objects dynamically (e.g., in a system where memory can be allocated to objects by a program while the program is running), the pattern in which objects are allocated may depend on run-time conditions, which may not be known beforehand. Dynamic allocation typically allows memory reuse and can, accordingly, generate large numbers of objects whose total memory size requirements could exceed the system memory resources at any given time.

In the C programming language, the library function malloc( ) is often used for allocation. In the C programming language, the library function free( ) is often used to release memory for objects that are no longer in use.

Allocation and freeing of dynamic memory should be performed carefully. If an application fails to reclaim unused memory, system memory requirements will grow over time and eventually exceed available resources. This kind of error is known as a memory leak. Another kind of error occurs when an application reclaims memory allocated to an object even though it still maintains a reference to the object. Typically, an application should not retain a reference to a memory location once that memory location is reclaimed because, if the reclaimed memory is reallocated for a different purpose, the application may inadvertently manipulate the same memory in multiple inconsistent ways. This kind of error is known as a dangling reference. Explicit dynamic memory management by using interfaces like malloc( ) and free( ) often leads to these problems.

In order to eliminate such errors, many object-oriented systems provide automatic memory reclamation, commonly referred to as garbage collection (GC). Garbage collectors operate by reclaiming space that they no longer consider reachable.

Statically allocated objects are reachable at all times while a program is running, and may refer to dynamically allocated objects, which are then also reachable. Objects referred by execution stacks and processor registers are reachable, as well. Moreover, any object referred to by a reachable object is itself reachable.

GC normally requires global knowledge of a system in order to allocate and reuse memory. For example, a developer working on a local piece of code will generally not know whether other parts of the system are using a particular object, so memory reclamation calls are extremely difficult to insert manually without error. By using GC, the developer may ensure proper allocation and reuse, leading to more robust systems with fewer memory leaks and no dangling references.

Programming languages executing on top of a virtual machine (VM) commonly rely on the VM being able to perform GC. Examples of such languages are Java, Smalltalk, Lisp, and others. However, an implementation may be written in practically any programming language and still make use of GC.

Since GC normally requires global knowledge, GC implementations may suffer from problems, such as excessive pause times. Application threads that mutate memory state, also known as mutators, need to make steady progress to solve tasks at hand. At the same time, GC may alter the memory that mutators work on. A common solution is to run GC in one or more separate threads, and when GC runs, all mutator threads are stopped. Gaining global knowledge of a system can be time-consuming, and mutator threads may then experience excessive pause times.

For example, assume a system must process digital signals at a rate of 20 packets per second. Processing a packet takes 10 milliseconds, and receiving and transmitting each takes another 10 milliseconds. This leaves 20 milliseconds of idle time of the 50 milliseconds available per packet. If GC runs for more than 20 milliseconds during any particular 50 millisecond interval, the system cannot keep up. It would be desirable to guarantee that during any particular 50 millisecond interval, GC will not pause mutators for more than 20 milliseconds.

In response to this problem, “incremental” or “real-time” GC algorithms have been developed. Garbage Collection: Algorithms for Automatic Dynamic Memory Management by Richard E. Jones and Rafael Lins (Wiley, 1996), which is incorporated herein by reference, contains a survey of prior art techniques. Some results have been obtained in the family of “non-compacting collectors,” which are collectors that never relocate an object in memory once it has been allocated. However, non-copying collectors suffer from the problem of memory fragmentation. In order to satisfy allocation requests of various sizes, a much larger total amount of memory may be needed, since smaller free segments are fragmented and cannot be coalesced into larger free segments.

The family of “copying collectors,” on the other hand, may choose to relocate objects to avoid fragmentation, leading to improved memory utilization. When relocating an object, in addition to copying the object itself, all references to the object must be updated before paused mutators can proceed. The amount of work required is potentially large, and maximum GC pause times cannot be guaranteed. One solution is to use indirect pointers, also known as object tables, but this leads to excessive memory use and a number of other problems (see, e.g., Garbage Collection, by Jones et al.). Other solutions include various “replicated based” copying collectors, but they impose sever performance penalties on mutators unless special hardware support is present.

As a result, systems requiring real-time response times on stock hardware, such as multimedia applications, have been forced to use error-prone manual memory handling techniques.

Garbage collection algorithms are commonly divided into three basic algorithms: mark/sweep, copying, and reference counting. Examples of possible marking and copying algorithms are:

Example of a basic marking algorithm:
1. Mark all reachable objects transitively, starting from global roots
2. Sweep memory, collect addresses of all unreachable objects and determine fragmentation level
3. Determine relocation effort based on fragmentation level
4. Relocate objects if necessary, and update all references to relocated objects

Example of a basic copying algorithm:
1. Relocate reachable objects, starting from global roots
2. Scan relocated objects, and relocate reachable non-relocated objects
3. Repeat until all reachable objects have been relocated

### SUMMARY

A technique for real-time allocation of objects during garbage collection (GC) involves guaranteeing bounds on mutator thread pause times. An example process according to the technique includes relocating an object in real-time during garbage collection, pausing mutator threads, bounding mutator pause times by scanning only one of a plurality of mutator threads, and resuming the mutator threads. In an embodiment, the process may further include trapping references to the relocated object and updating the references using a forwarding pointer that is associated with the old object.

Another example of a process according to the technique includes suspending a plurality of threads, relocating the object to a second memory location, updating references associated with the first memory location, for only one of the threads, to the second memory location, and resuming the threads. In an embodiment, the process may include initially marking each of the threads “unscanned.” In another embodiment, the process may include reading the object from the first memory location and writing the object to the second memory location.

In an embodiment, the process may include patching a class pointer associated with the object at the first memory location to a trap class. In another embodiment, the process may further include inserting a forwarding pointer into the object at the first memory location, wherein the forwarding pointer points to the object at the second memory location. In another embodiment, the process may further include using the forwarding pointer to update a pointer to the first memory location to the second memory location.

In an embodiment, the process may include updating a pointer to the first memory location to the second memory location. In another embodiment, the process may include scanning a global stack to find the pointer to the first memory location. In another embodiment, the process may include scanning a next-runnable thread stack to find the pointer to the first memory location.

In an embodiment, the process may include selecting the next-runnable thread, scanning a next-runnable thread stack associated with the next-runnable thread, and marking the next runnable thread “scanned”. In another embodiment, the process may include updating a pointer to the first memory location in the next-runnable thread stack to point to the second memory location.

In an embodiment, the process may include executing a second of the plurality of threads, wherein the second thread includes a class reference associated with the first memory location, and associating the class reference to the second memory location. In another embodiment, the process may include trapping the class reference. In another embodiment, the process may include updating the class reference using a forwarding pointer. In another embodiment, the process may include marking the second of the plurality of threads “scanned.”

In an embodiment, the process may include suspending the plurality of threads a second time, selecting a second of the plurality of threads, scanning a stack associated with the second thread, marking the second thread “scanned,” and resuming the threads a second time. In another embodiment, the process may include reclaiming memory associated with the first memory location when it is determined that each of the plurality of threads has been scanned.

An example system according to the technique includes a scheduler and a relocation engine. In an embodiment, the scheduler may suspend mutator threads in preparation for dynamic object relocation.

In an embodiment, the relocation engine may, in cooperation with the scheduler, mark mutator threads as “unscanned.” In another embodiment, the relocation engine may be configured to do one or more of: read a first object, write a second object that is associated with the first object, patch a class pointer associated with the first object to a trap class, set a forwarding pointer to the second object at the first object, scan a global stack, update references to the first object, if any, according to the forwarding pointer, select a first thread of the suspended mutator threads, scan a mutator stack associated with the first thread, update references to the first object, if any, according to the forwarding pointer, and mark the first thread of the suspended mutator threads as “scanned.”

In an embodiment, the scheduler is further configured to resume the mutator threads after marking the first thread as scanned and before scanning a second mutator stack associated with a second thread of the suspended mutator threads.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a conceptual view of a system for relocating an object at run-time according to an embodiment.

FIGS. 2A and 2B depict conceptual views of objects and stacks before and after relocation according to an embodiment.

FIG. 3 depicts a flowchart of a process according to an embodiment.

FIG. 4 depicts a flowchart of another process according to an embodiment.

FIG. 5 depicts a flowchart of another process according to an embodiment.

FIG. 6 depicts a flowchart of another process according to an embodiment.

FIG. 7 depicts a networked system for use in an embodiment.

FIG. 8 depicts a computer system for use in the system of FIG. 7.

### DETAILED DESCRIPTION

A garbage collector may be executed on a stock hardware system with a number of mutator threads (each with an associated thread state), as scheduled by a scheduler. The system may include one or more processors that act on memory objects. Objects may be represented in memory in many ways.

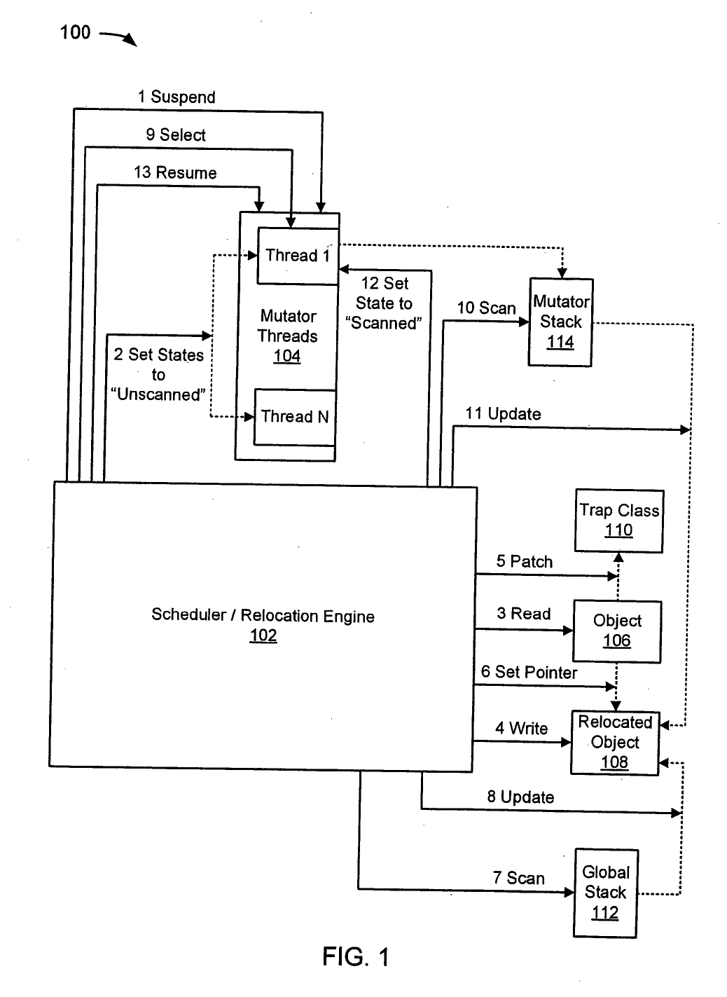

FIG. 1 depicts a conceptual view of a system 100 for relocating an object at run-time according to an embodiment. The system 100 includes a scheduler/relocation engine 102, mutator threads 104, an object 106, a relocated object 108, a trap class 110, a global stack 112, and a mutator stack 114.

The scheduler/relocation engine 102 may be coupled to a processor (not shown). The scheduler portion of the scheduler/relocation engine 102 may include computer hardware, firmware, or software that arranges jobs to be done by the system 100 in an order. Scheduler functionality is well-known so an in-depth discussion of scheduling is not provided herein. The relocation engine portion of the scheduler/relocation engine 102 may include computer hardware, firmware, or software that moves an object from one memory location to another, and updates pointers to the old memory location. When some or all of the pointers are updated, a garbage collector reclaims the old memory location so that the memory can be reallocated. The scheduler/relocation engine 102 may be designed as a single application, two applications (e.g., a scheduler and relocation engine/garbage collector), or three or more applications.

The mutator threads 104 are execution threads active in the runtime environment of the system 100. The mutator threads 104 may be stored, for example, in memory (not shown). In an embodiment, each mutator thread has an associated state that may include a scanned/unscanned state indicator. Each thread typically has an associated stack. Since stacks are well-understood in the art of computer programming, an in-depth discussion of stacks is not provided herein. In the example of FIG. 1, the mutator stack 114 is associated with “Thread 1” and other mutator stacks (not shown) are understood to be associated with Threads 2..N.

The object 106 may be stored, for example, in memory. Prior to relocation, the object 106 may be referred to as “the original object.” The representation of objects in memory is well-known so an in-depth discussion of various representations is not provided herein. It should suffice to assume that an object includes a number of fields, one of which may be a class pointer to a class that is associated with the object, and others of which may be data fields.

The relocated object 108 is similar to the object 106. In an embodiment, as the object is relocated, fields of the object 106 and the relocated object 108 may be changed, such that, at some point, fields of the object 106 are different from those of the relocated object 108.

The trap class 110 may be stored, for example, in memory. The trap class 110 is a class that provides a specific functionality to the object 106. For example, when a method invocation is made to the object 106 (after relocation), the trap class includes a method for updating the referencing pointer to point to the relocated object 108, then resuming execution of the original method invocation. Thus, pointers to the object 106 can be efficiently updated in runtime. Advantageously, this technique imposes zero or almost zero overhead on regular method invocations.

The global stack 112 may be stored in memory. Like thread stacks, global stacks are well-understood, so an in-depth discussion of the global stack 112 is not provided herein.

In operation, in the example of FIG. 1, the scheduler/relocation engine 102 suspends the execution of the mutator threads 104 when an object is to be relocated. In the example of FIG. 1, this step (1) is indicated by the arrow labeled “1 Suspend.” Subsequent steps are indicated by arrows labeled (2) to (13).

In the example of FIG. 1, after suspending the mutator threads 104, the scheduler/relocation engine 102 sets (2) states associated with each of the threads to “unscanned.” Then, the scheduler/relocation engine 102 reads (3) the object 106 and writes (4) the object to a new memory location as the relocated object 108. The scheduler/relocation engine 102 patches (5) the object 106 to a trap class and sets (6) a forwarding pointer from the object 106 to the relocated object 108.

In the example of FIG. 1, after the object has been relocated and updated, the scheduler/relocation engine 102 scans (7) the global stack 112 and updates (8) any pointers to the object 106 to the relocated object 108, using the forwarding pointer. The scheduler/relocation engine 102 then selects (9) a first thread of the mutator threads 104, scans (10) the mutator stack 114 associated with the thread, and updates (11) any pointers to the object 106 to the relocated object 108, using the forwarding pointer. After the scan, the scheduler/relocation engine 102 sets (12) the state associated with the mutator stack 114 to “scanned.”

In the example of FIG. 1, the scheduler/relocation engine 102 then resumes (13) execution of the mutator threads 104. Advantageously, the mutator threads 104 are only suspended long enough to update the global stack 112 and the mutator stack 114. Thus, the scheduler/relocation engine 102 may be referred to as being bounded, since only one execution stack is scanned.

In another embodiment, the scheduler/relocation engine 102 select, scan, update pointers, and set state to “scanned” for each additional thread. This only occurs when the thread is executed, so the scheduler/relocation engine 102 may be referred to as bounded for each thread (since only the stack associated with that thread is processed).

In should be noted that the scheduler/relocation engine 102 could just perform steps 1-8 and 12-13. Later, when an unscanned mutator thread is executed, references to the object 106 result in an update to the reference, using the trap class 110 and the forwarding pointer of the object 106. In this way, steps 9-11 are performed, essentially, on the fly. However, since, in an embodiment, the next-runnable thread is known, it may be more efficient for the scheduler/relocation engine 102 to perform steps 1-13 straight through, as previously described.

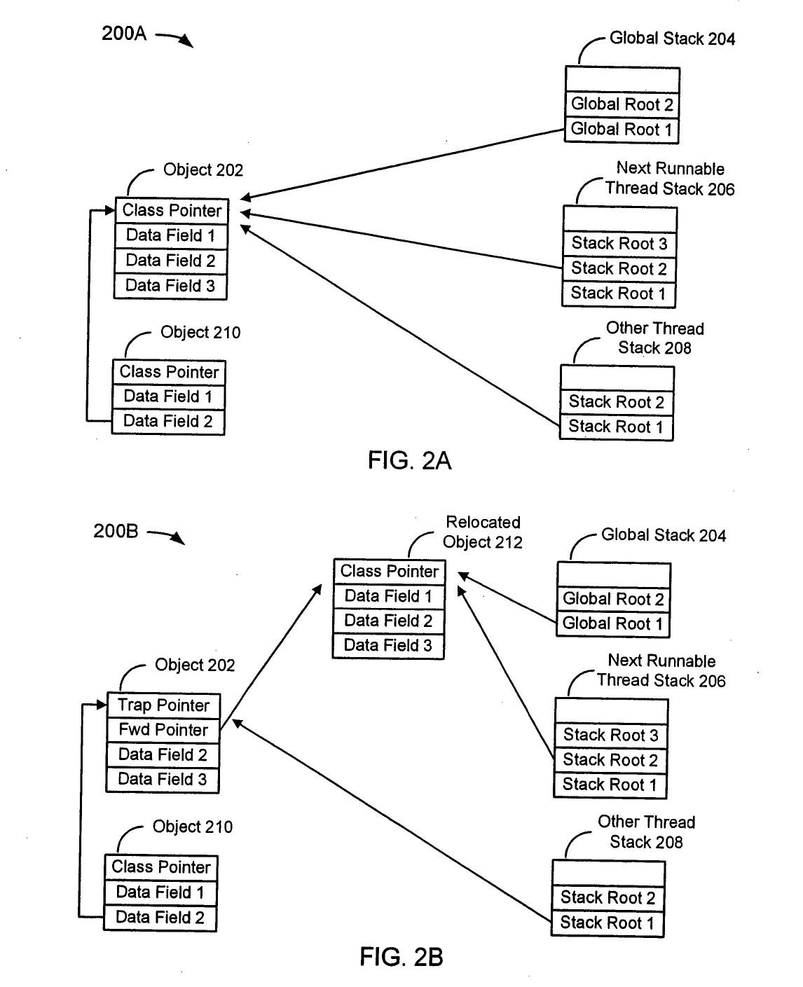

FIGS. 2A and 2B depict conceptual views of objects and stacks before (FIG. 2A) and after (FIG. 2B) relocation according to an embodiment. FIG. 2A depicts a “before” view 200A that includes an object 202, a global roots stack 204, a next-runnable thread stack 206, an other thread stack 208, and an object 210.

In the example of FIG. 2A, the object 202 includes four fields: a class pointer field and three data fields. The class pointer field and three data fields each may or may not be one word in size. The class pointer field presumably points (not shown) to class-related data. The object 210 is similar to the object 202 though, for illustrative purposes only, the object 210 includes a class pointer field (which may point to class-related data that is the same or different than the class-related data associated with the object 202) and two data fields.

It should be noted that the representation of objects in memory is well-known so an in-depth discussion of various representation techniques is not described herein. The objects 202, 210 are intended to serve, for illustrative purposes, as one of a practically infinite number of object representations.

In the example of FIG. 2A, the global stack 204 includes two global roots, the next-runnable thread stack 206 includes three stack roots, and the other thread stack 208 includes two stack roots. The number of roots depicted is only for illustrative purposes. As shown in the example of FIG. 2A, initially one root from each of the stacks 204, 206, and 208 includes a pointer to the object 202. Also, a data field of the object 210 includes a pointer to the object 202.

FIG. 2B depicts an “after” view 200B that is similar to the “before” view 200A, but includes a relocated object 212. After the relocated object 212 has been created, the object 202 is updated by changing the class pointer to a trap class pointer that points to a trap class and the first data field to a forwarding pointer that points to the relocated object 212. In an embodiment, the trap class includes a method that serves to update a reference to the object 202 such that the reference is to the relocated object 212. In this way, a method call to the object 202 can be handled by the relocated object 212 and subsequent method calls are directed to the relocated object 212 (at least for the object that invoked the method).

In an embodiment, the global stack 204 is scanned for all pointers to the object 202 and updated so that the pointers point to the relocated object 212. Similarly, the next-runnable thread stack 206 is scanned for all pointers to the object 202 and updated so that the pointers are to the relocated object 212. These updates are illustrated in the “after” view 200B as arrows from the global stack 204 and the next-runnable thread stack 206 to the relocated object 212. It may be noted that zero or multiple roots from a single stack (e.g., the global stack 204) could reference the relocated object 212, in which case, if illustrated as in FIG. 2B, no arrows or multiple arrows would be drawn from zero or multiple roots to the relocated object 212.

In an embodiment, only one executable stack (i.e., the next-runnable thread stack 206) is updated. As depicted in FIG. 2B, the other thread stack 208 is not updated. Rather, a root of the other thread stack 208 points to the object 202. If the other thread stack 208 is executed, then the reference to the object 202 may be “trapped” by the trap class pointer and the reference updated using the forwarding pointer. In this way, the other thread stack 208 can be updated on the fly to point to the relocated object 212. Similarly, a reference from the object 210 to the object 202 can be trapped and updated using the forwarding pointer.

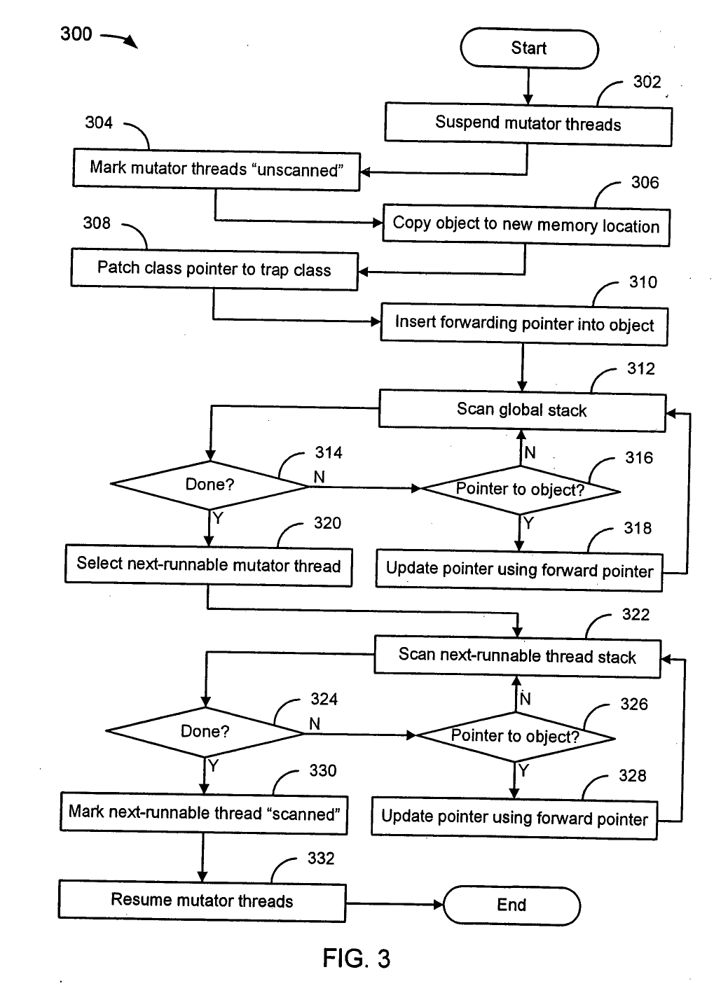

FIG. 3 depicts a flowchart 300 of a process according to an embodiment. The flowchart 300 is intended to illustrate the relocation of an object and update of a global stack and a single execution stack. The process depicted in the example of FIG. 3 is bounded since a single execution stack is updated while execution is suspended, and execution resumes thereafter. This process and other processes are depicted as serially arranged modules. However, modules of the processes may be reordered, or arranged for parallel execution as appropriate.

In the example of FIG. 3, the flowchart 300 starts at module 302 with suspending mutator threads. The mutator threads are suspended prior to relocating an object at runtime. This is important to avoid, for example, dangling references.

In the example of FIG. 3, the flowchart 300 continues at module 304 with marking mutator threads “unscanned.” By marking the mutator threads, or otherwise indicating that a mutator thread has not yet been scanned, a system is able to distinguish between those mutator threads that have been updated since an object was relocated and those mutator threads that may still include a dangling reference.

In the example of FIG. 3, the flowchart 300 continues at module 306 with copying an object to a new location. This may entail reading an object from one memory location and writing the object to another memory location. For large objects, this step can be potentially time-consuming. Known techniques exist to alleviate this problem.

In the example of FIG. 3, the flowchart 300 continues at module 308 with patching a class pointer to a trap class. The object that is to be relocated is presumably associated with a class. In an aspect of an embodiment, the class pointer references class-related methods and data. After the object has been copied to a new memory location, the old object class pointer becomes unnecessary. So, the class pointer is changed to a trap class pointer. The trap class includes methods and data that are sufficient to redirect a reference from the old memory location to the new memory location. As used herein, the term “trapping” refers to intercepting a method call (or other reference related to the object) for the object at the old memory location.

In the example of FIG. 3, the flowchart 300 continues at module 310 with inserting a forwarding pointer into the object. Since the data fields of the object have already been copied to the new memory location, the first data field (after the trap class pointer) can be employed to contain the forwarding pointer. The forwarding pointer points to the new memory location. In operation, a reference to the old memory location is trapped using a method associated with a trap class (see, e.g., module 308) and redirected to the new memory location using the forwarding pointer.

It may be noted that, in an embodiment, the old memory location need not contain any more than the trap class pointer and the forwarding pointer. Accordingly, in an embodiment, the memory associated with the data fields of the old memory location could be reclaimed. Though this is an advantage associated with implementations according to the teachings provided herein, immediate reclamation of part of the object is not critical to operation.

In the example of FIG. 3, the flowchart 300 continues at module 312 with scanning a global stack. One issue that needs to be addressed in any implementation that includes garbage allocation is the issue of global references. Since it is often impossible to determine, from a local perspective, whether global references to an object may be made, the global references should be updated. Accordingly, scanning the global stack is of some importance. The global stack may or may not be scanned one root at a time, but for illustrative purposes, at least with reference to the flowchart 300, it is assumed that one root is scanned at a time.

In the example of FIG. 3, the flowchart 300 continues at decision point 314 where it is determined whether scanning is complete. Unless the global stack is initially empty, it will be determined that scanning is not complete.

If scanning is not complete (314-N), then the flowchart 300 continues at decision point 316 where it is determined whether the current root includes a pointer to the object. If the current root does not include a pointer to the object (316-N), then the root need not be modified and, at module 312, the flowchart 300 simply continues scanning the global stack. If, on the other hand, the current root does include a pointer to the object (316-Y), then the flowchart 300 continues at module 318 with updating the pointer using the forwarding pointer. Accordingly, a global root that pointed to the old memory location is updated to point to the new memory location of the object. The flowchart 300 then continues from module 312.

Eventually, each root of the global stack will have been considered and, at decision point 314, it will be determined that scanning of the global stack is complete. When scanning of the global stack is complete (314-Y), the flowchart 300 continues at module 320 with selecting a next-runnable mutator thread and at module 322 with scanning the next-runnable thread stack. As the name of the thread implies, the thread is next in line (as determined by, for example, a scheduler) to be executed when the executable threads resume execution.

In the example of FIG. 3, the flowchart 300 continues at decision point 324 where it is determined whether scanning is complete. Unless the next-runnable thread stack is initially empty (which is unlikely), it will be determined that scanning is not complete.

If scanning is not complete (324-N), then the flowchart 300 continues at decision point 326 where it is determined whether the current root includes a pointer to the object. If the current root does not include a pointer to the object (326-N), then the root need not be modified and, at module 322, the flowchart 300 simply continues scanning the next-runnable thread stack. If, on the other hand, the current root does include a pointer to the object (326-Y), then the flowchart 300 continues at module 328 with updating the pointer using the forwarding pointer. Accordingly, a stack root that pointed to the old memory location is updated to point to the new memory location of the object. The flowchart 300 then continues from module 322.

Eventually, each root of the next-runnable thread stack will have been considered and, at decision point 324, it will be determined that scanning of the next-runnable thread stack is complete. When scanning of the next-runnable thread stack is complete (324-Y), the flowchart 300 continues at module 330 with marking the next-runnable thread as “scanned.”

In the example of FIG. 3, the flowchart 300 continues at module 332 with resuming the mutator threads. Then the flowchart 300 ends. Since the mutator threads resume execution after scanning only one of the mutator thread stacks, the process described with reference to FIG. 3 is bounded. It should be noted that there may be additional references to the old memory location that were not updated in, for example, other objects or in other mutator thread stacks.

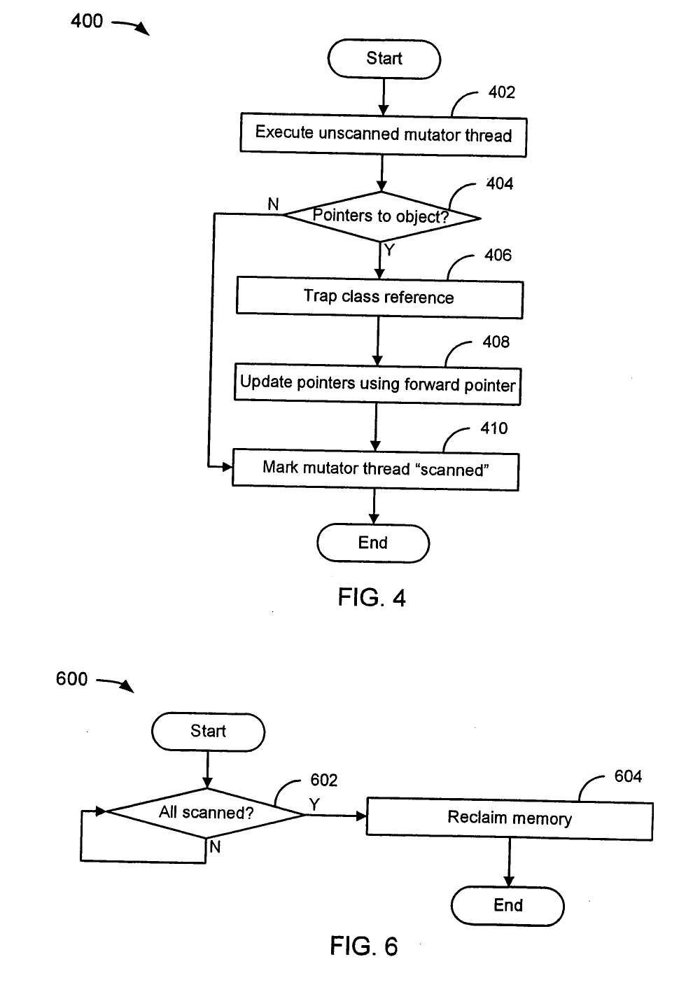

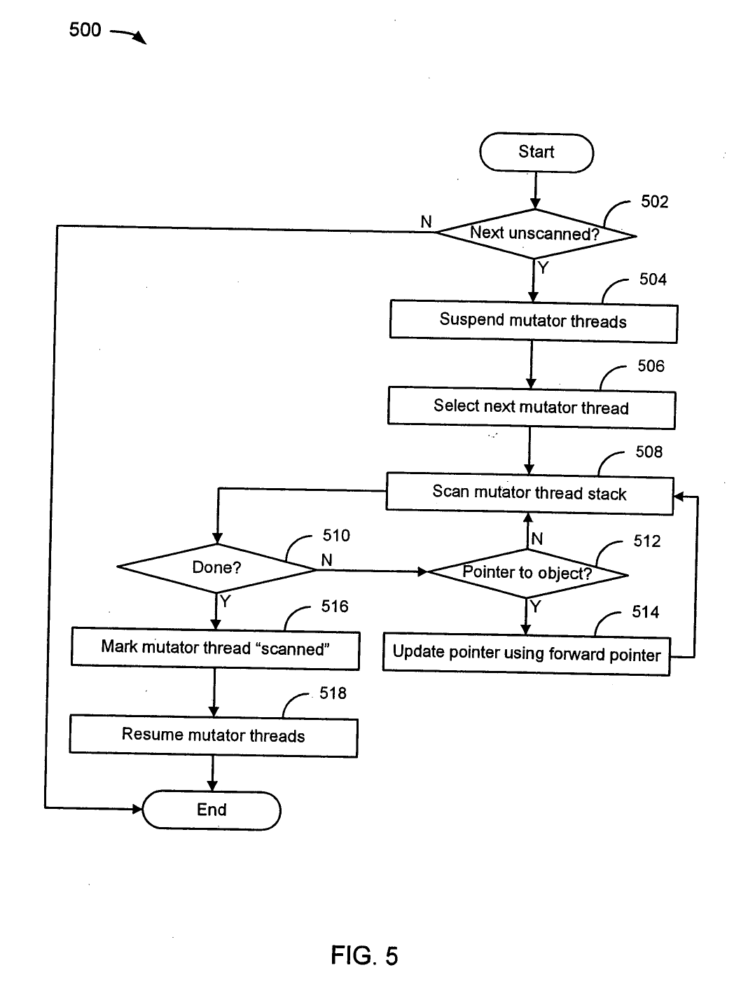

FIGS. 4 and 5 depict alternative processes for updating the references. FIG. 4 depicts a flowchart 400 of a process according to an embodiment. FIG. 4 is intended to illustrate the processing of unscanned mutator threads. It is assumed that the global stack has already been scanned and one or more mutator threads have been marked “unscanned” before the start of the flowchart 400. The next-runnable thread stack may or may not have already been scanned. If the next-runnable thread stack has not been scanned then, in an embodiment, the flowchart 400 may start with the next-runnable thread stack. If the next-runnable thread stack has already been scanned then, in another embodiment, the flowchart 400 may start with a subsequent thread stack.

In the example of FIG. 4, the flowchart 400 starts at module 402 with executing an unscanned mutator thread. The mutator thread may be marked “unscanned” or the fact that the mutator thread is unscanned may be indicated in some other manner. When the mutator thread is to be executed, since the mutator thread has not been scanned, there may be pointers to an old memory location.

Accordingly, in the example of FIG. 4, the flowchart 400 continues at decision point 404 with determining whether there are any pointers to an object that has been relocated. If there are pointers to the object (404-Y), then the flowchart 400 continues at module 406 with trapping the class reference and at module 408 with updating pointers using a forward pointer. The modules 404 to 408 may be accomplished by checking each root of the associated mutator thread, or by checking each root in parallel. In this way, any roots that point to the old memory location are updated to point to the new memory location.

In the example of FIG. 4, the flowchart 400 continues at module 410 with marking the mutator thread as “scanned.” Alternatively, the mutator thread may be indicated as scanned in some other manner. Then the flowchart 400 ends.

FIG. 5 depicts a flowchart 500 of a process according to another embodiment. FIG. 5 is intended to illustrate the processing of unscanned mutator threads. It is assumed that the global stack has already been scanned and one or more mutator threads have been marked “unscanned” before the start of the flowchart 500. The next-runnable thread stack may or may not have already been scanned. If the next-runnable thread stack has not been scanned then, in an embodiment, the flowchart 500 may start with the next-runnable thread stack. If the next-runnable thread stack has already been scanned then, in another embodiment, the flowchart 500 may start with a subsequent thread stack.

In the example of FIG. 5, the flowchart 500 starts at decision point 502 where it is determined whether a next unscanned mutator thread exists. The mutator thread may be marked “unscanned” or the fact that the mutator thread is unscanned may be indicated in some other manner. Since the next unscanned mutator thread has not been scanned, there may be pointers to an old memory location. If there is no next unscanned mutator thread, then the flowchart 500 simply ends.

Otherwise, if a next unscanned mutator thread exists (502-Y), then the flowchart 500 continues at module 504 with suspending the mutator threads and at module 506 with selecting the next unscanned mutator thread.

In the example of FIG. 5, the flowchart 500 continues at module 508 with scanning the unscanned mutator thread stack. In the example of FIG. 5, the flowchart 500 continues at decision point 510 where it is determined whether scanning is complete. Unless the unscanned mutator thread stack is initially empty (which is unlikely), it will be determined that scanning is not complete.

If scanning is not complete (510-N), then the flowchart 500 continues at decision point 512 where it is determined whether the current root includes a pointer to the object. If the current root does not include a pointer to the object (512-N), then the root need not be modified and, at module 508, the flowchart 500 simply continues scanning the unscanned mutator thread stack. If, on the other hand, the current root does include a pointer to the object (512-Y), then the flowchart 500 continues at module 514 with updating the pointer using the forwarding pointer. Accordingly, a mutator stack root that pointed to the old memory location is updated to point to the new memory location of the object. The flowchart 500 then continues from module 508.

Eventually, each root of the unscanned mutator thread stack will have been considered and, at decision point 510, it will be determined that scanning of the unscanned mutator thread stack is complete. When scanning of the unscanned mutator thread stack is complete (51 0-Y), the flowchart 500 continues at module 516 with marking the unscanned mutator thread as “scanned.”

In the example of FIG. 5, the flowchart 500 continues at module 518 with resuming the mutator threads. Then the flowchart 500 ends. Since the mutator threads resume execution after scanning only one of the mutator thread stacks, the process described with reference to FIG. 5 is bounded. It should be noted that there may be additional references to the old memory location that were not updated in, for example, subsequent mutator thread stacks. These references may be updated in the same manner as just described, in, in an embodiment, a serial fashion.

FIGS. 4 and 5 may be repeated until all thread stacks have been scanned. At this point, it may be determined that the memory associated with the object may or may not be reclaimed. FIG. 6 depicts a flowchart 600 of a process according to another embodiment where the memory associated with the object is to be reclaimed. The flowchart 600 starts at decision point 602 where it is determined whether all executable threads have been scanned. If so (602-Y), then the memory is reclaimed at module 604 and the flowchart 600 ends. If not (602-N), then the flowchart 600 repeats until all threads have been scanned. It may be noted that this does not necessarily entail a program that continuously checks whether all threads have been scanned. Rather, for example, a check may be made after a thread is scanned.

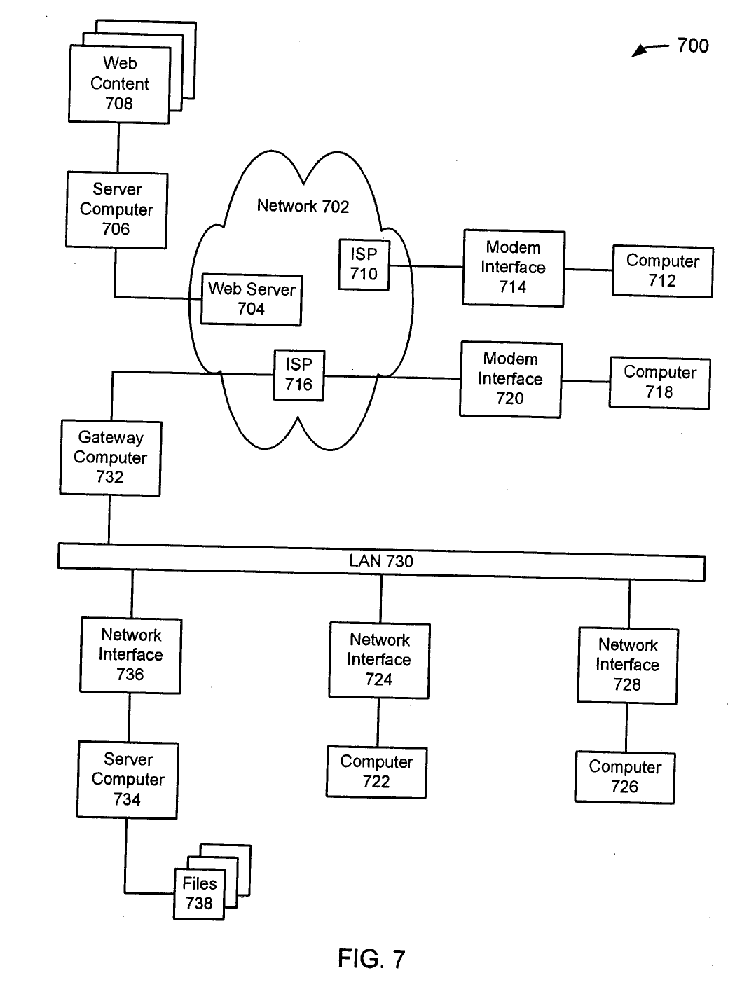

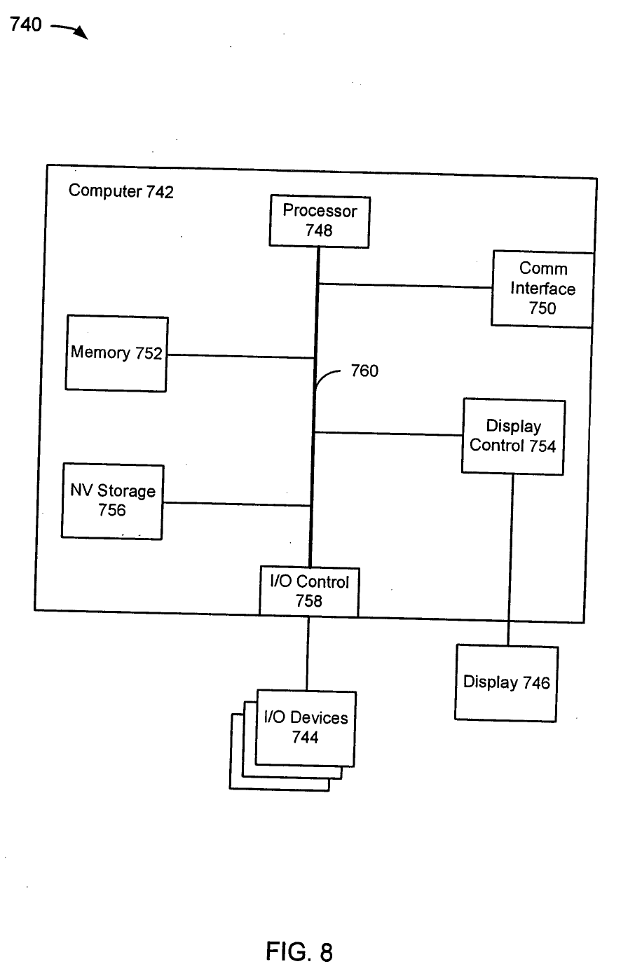

The following description of FIGS. 7 and 8 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 704 is typically at least one computer system which operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a form of a media database. While two computer systems 704 and 706 are shown in FIG. 7, the web server system 704 and the server computer system 706 can be one computer system having different software components providing the web server functionality and the server functionality provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be ethernet network or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730,through a network interface 736 to provide files 738 and other services to the clients 722 and 726, without the need to connect to the Internet through the gateway system 732.

FIG. 8 depicts a computer system 740 for use in the system 700 (FIG. 7). The computer system 740 may be a conventional computer system that can be used as a client computer system or a server computer system or as a web server system. Such a computer system can be used to perform many of the functions of an Internet service provider, such as ISP 710 (FIG. 7).

In the example of FIG. 8, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, isdn modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. One of skill in the art will immediately recognize that the terms “machine-readable medium” or “computer-readable medium” includes any type of storage device that is accessible by the processor 748 and also encompasses a carrier wave that encodes a data signal.

Objects, methods, inline caches, cache states and other object-oriented components may be stored in the non-volatile storage 756, or written into memory 752 during execution of, for example, an object-oriented software program. In this way, the components illustrated in, for example, FIGS. 1, 2A, and 2B can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 752 for execution by the processor 748. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows®V from Microsoft Corporation of Redmond, Washington, and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or, advantageously, it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

As used herein, garbage collection is part of a language's runtime system, or an add-on library, perhaps assisted by a compiler, the hardware, the operating system, or any combination of three, that determines what memory a program is no longer using, and recycles it for other use. This is sometimes referred to as automatic memory reclamation.

While this invention has been described by way of example in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A process, comprising:
pausing mutator threads as part of a relocation procedure;
relocating an object in real-time during garbage collection as part of the relocation procedure;
bounding mutator pause times by scanning only one of a plurality of mutator threads during the relocation procedure; and
resuming the mutator threads as part of the relocation procedure.

2. The process of claim 2, further comprising:
trapping references to the relocated object and updating the references using a forwarding pointer.

3. A process for dynamically relocating an object during garbage collection, comprising:
suspending a plurality of threads, wherein at least two of the plurality of threads include a reference to an object at a first memory location;
relocating the object to a second memory location;
updating references associated with the first memory location, for only one of the plurality of threads, to the second memory location; and
resuming the plurality of threads.

4. The process of claim 3, further comprising marking each of the plurality of threads “unscanned” to indicate that it has not been determined whether the plurality of threads have been updated in response to the relocating of the object.

5. The process of claim 3, further comprising:
reading the object from the first memory location; and
writing the object to the second memory location.

6. The process of claim 5, further comprising patching a class pointer associated with the object at the first memory location to a trap class.

7. The process of claim 5, further comprising inserting a forwarding pointer into the object at the first memory location, wherein the forwarding pointer points to the object at the second memory location.

8. The process of claim 7, further comprising using the forwarding pointer to update a pointer to the first memory location to the second memory location.

9. The process of claim 3, further comprising updating a pointer to the first memory location to the second memory location.

10. The process of claim 9, further comprising scanning a global stack to find the pointer to the first memory location.

11. The process of claim 9, further comprising scanning a next-runnable thread stack to find the pointer to the first memory location.

12. The process of claim 3, wherein said one of the plurality of threads is a next-runnable thread, further comprising:
selecting the next-runnable thread;
scanning a next-runnable thread stack associated with the next-runnable thread; and
marking the next runnable thread “scanned”.

13. The process of claim 12, further comprising updating a pointer to the first memory location in the next-runnable thread stack to point to the second memory location.

14. The process of claim 3, further comprising:
executing a second of the plurality of threads, wherein the second of the plurality of threads includes a class reference associated with the first memory location; and
associating the class reference to the second memory location.

15. The process of claim 14, further comprising trapping the class reference.

16. The process of claim 14, further comprising updating the class reference using a forwarding pointer.

17. The process of claim 14, further comprising marking the second of the plurality of threads “scanned”.

18. The process of claim 3, further comprising:
suspending the plurality of threads a second time;
selecting a second of the plurality of threads;
scanning a stack associated with the second of the plurality of threads;
marking the second of the plurality of threads “scanned” ; and
resuming the plurality of threads a second time.

19. The process of claim 3, further comprising reclaiming memory associated with the first memory location when it is determined that each of the plurality of threads has been scanned.

20. A system, comprising:
a scheduler configured to suspend mutator threads for dynamic object relocation;
a relocation engine for, in cooperation with the scheduler, marking mutator threads as “unscanned”, wherein said relocation engine is configured to:
read a first object,
write a second object that is associated with the first object,
patch a class pointer associated with the first object to a trap class,
set a forwarding pointer to the second object at the first object,
scan a global stack,
update references to the first object, if any, according to the forwarding pointer,
select a first thread of the suspended mutator threads,
scan a mutator stack associated with the first thread,
update references to the first object, if any, according to the forwarding pointer, and
mark the first thread of the suspended mutator threads as “scanned” ; wherein
said scheduler is further configured to resume the mutator threads after marking the first thread as scanned and before scanning a second mutator stack associated with a second thread of the suspended mutator threads.
